(19) United States
(12) Patent Application Publication
(10) Pub. No.: US 2019/0106912 A1
(43) Pub. Date: Apr. 11, 2019

(54) METHOD FOR MOUNTING A DOOR HANDLE SUPPORT IN A FINAL POSITION AND DOOR HANDLE SUPPORT FASTENING SET

(71) Applicants: Ralf Lennhoff, Hagen (DE); Pedro Dias, Velbert (DE)

(72) Inventors: Ralf Lennhoff, Hagen (DE); Pedro Dias, Velbert (DE)

(73) Assignee: Huf Huelsbeck & Fuerst GmbH & Co. KG, Velbert (DE)

(21) Appl. No.: 16/136,366

(22) Filed: Sep. 20, 2018

(30) Foreign Application Priority Data
Oct. 6, 2017 (DE) 10 2017 123 289.3

(51) Int. Cl. E05B 79/06; E05B 85/18

(52) U.S. Cl. CPC E05B 79/06; E05B 85/18

(57) ABSTRACT

A method for mounting a door handle support in a final position on a vehicle door provided with a door handle cutout includes providing a vehicle door having an outer surface and an inner surface, connecting a fastening adapter to the inner surface of the door, positioning an adapter cap on the fastening adapter, and positioning the door handle support on the adapter cap in an abutting position. The door handle support is fastened by fastening screws. Optionally, a paint bezel is applied on the door handle support. A door handle support fastening set is also disclosed.

### BACKGROUND

The invention refers to a method for mounting a door handle support in a final position on a vehicle door. The invention also refers to a door handle support fastening set for mounting a door handle support in a final position on a vehicle door.

Door handles of a vehicle door are usually positioned on a door handle support in order to simplify mounting operations. The door handle support is in turn fastened on the inside of the vehicle door in such a way that the door handle may be accessed through a hole present in the door metal sheet from outside the vehicle. The mounting of the door handle support on the inside of a door is normally performed by observing strict requirements regarding the positioning precision of the door handle support to be mounted. The positioning of the door handle support in a mounted state should on one hand provide pleasant esthetics and also fulfill strict requirements regarding still tolerated gaps, water tightness and similar. Due to the high requirements in particular with regard to the positioning precision, the mounting of a door handle support is difficult and thus requires a lot of time.

The object of the present invention is thus to provide an economic and universally applicable way for quickly fastening a door handle support to the inner side of a vehicle door and also to fulfill the highest requirements regarding the positioning precision.

### BRIEF SUMMARY

This object is achieved by a method for mounting a door handle support. The mounting of the door handle support in a final position on the vehicle door is thereby possible. This means that the method is suitable for achieving a fastening of the door handle support on the vehicle door in such a way that after completion of the method, the door handle support is positioned in a completely functional state on the vehicle door and that, except for possible slight readjustments, no correction of the position of the door handle support is required.

The method comprises the provision of a vehicle door. The vehicle door has an outer surface of the door and an inner surface of the door as well as a door handle cutout. The door handle cutout is used for fastening the door handle support from an inner side of the door in such a way that after fastening the door handle support on the vehicle door, a door handle actuation may be accomplished from outside through the door handle cutout or by engaging into the door handle cutout.

Moreover, a fastening adapter is provided, which is connected to an inner surface of the vehicle door. The connection may be performed by welding, gluing or a combination thereof, for example. The fastening adapter is formed and is fastened to the inner surface of the door in such a way that the fastening adapter at least partially surrounds the door handle cutout. Preferably, the fastening adapter completely surrounds the door handle cutout, i.e. the door handle cutout is completely surrounded or delimited by the fastening adapter. The fastening adapter has at least a first threaded hole and a second threaded hole, preferably the fastening adapter has at least three threaded holes.

The inventive method also provides the step wherein the adapter cap is positioned on the fastening adapter, i.e. after positioning the fastening adapter, the adapter cap is positioned on the inner surface of the door in such a way that that adapter cap envelopes the fastening adapter at least in a portion of the fastening adapter. It is not strictly necessary but preferred, if the adapter cap surrounds the fastening adapter along the entire circumference of the fastening adapter around the door handle cutout.

The adapter cap has at least one abutment means, preferably a plurality of abutment means. According to the invention, the method is characterized in that the abutment means, when the adapter cap is positioned on the door inner side onto the fastening adapter, is positioned in abutment against the vehicle door. The abutment means are adapted to the vehicle door in such a way that the positioning of the adapter cap causes and contributes to the final positioning of the adapter cap when applying the abutment means or the plurality of abutment means against the vehicle door. In other words, the vehicle door has a cutout to which the abutment means are adapted, as a complementary structure, in a way that the abutment means abutting against the cutout cause the final positioning of the adapter cap, in that, for example, the abutment means are supported by the vehicle door.

From the above it may be deduced, inter alia, that a portion of the adapter cap is positioned further away from the inner surface of the vehicle door than the fastening adapter or at least a portion of the fastening adapter, whilst another portion of the adapter cap is brought into direct contact and in abutment against the inner side of the door.

After positioning the adapter cap on the fastening adapter, the door handle support is applied on the adapter cap and is secured by fastening the fastening screws. The fastening screws are at least screwed in the first and second threaded hole, wherein preferably three threaded holes and three corresponding fastening screws are provided.

The inventive method is thus based in particular on the provision of the fastening adapter and of the adapter cap. The fastening adapter and the adapter cap are adapted to each other on the one hand and to the specific combination of a vehicle door and door handle support on the other hand. Due to the fact that the fastening adapter and the adapter cap are adapted to door, door handle support and to each other, it is achieved, that the fastening adapter may be reliably fastened to the door. To this end, for example, a suitable material selection and a corresponding shape of the fastening adapter may contribute. In particular an at least portion-wise adaptation of a profile of the fastening adapter to the door inner surface profile may be provided.

Due to the adaptation of the adapter cap to the vehicle door it is possible that the adapter cap may already be positioned on the vehicle door in its final position. Due to the fact that the adapter cap and the fastening adapter are adapted to each other, the adapter cap applied on the vehicle door suitably surrounds the fastening adapter. In particular, the adapter cap is provided with required screw holes, through which screws may be guided to the threaded holes of the fastening adapter.

The adapter cap is also designed in such a way that when the door handle support is resting on the adapter cap, a positioning of the door handle support relative to the outer surface of the door and inner surface of the door may be at least assisted. Whether the final positioning, in particular in a surface or direction parallel to the vehicle door surfaces, through the vehicle door itself or for instance also through the adapter cap, may be decided by the person skilled in the art. It is important that the fastening adapter and the adapter form two intermediate elements, which are positioned on the vehicle door prior to the fastening of the door handle support, and which contribute to the positioning and fastening of the door handle support on the door.

Due to the fact that the fastening adapter and the adapter cap are adapted to the vehicle door and door handle support and also to each other, the present method allows an individual pairing of fastening adapter and adapter cap for a specific vehicle type or a specific door shape. The fastening adapter and the adapter cap substantially compensate differences in the forms of the corresponding doors. Thus the door handle support may be provided, at least within certain limits, as a universal component. This in turn has the advantageous secondary effect, that the door handle support may be produced in high quantities, and thus in a cost-effective way.

A further essential aspect of the inventive method is that the fastening positions for the door handle support, i.e. the threaded holes of the fastening adapter, and a positioning aid for the door handle support, i.e. the adapter cap, are provided by two separately provided components. Thus a great adaptation flexibility is obtained, both for the inner surface of the door and the door handle support. Last but not least, the fastening adapter and the adapter cap may be fabricated independently from each other, so that the best properties, for example, regarding material composition or mechanical properties may be selected for both elements.

The abutment means may be an engagement slot, for example, which is introduced into an engagement spring of the inner surface of the door. Alternatively or additionally, the abutment means may be an engagement edge, which is positioned in abutment on the boundary of the door handle cutout, for final positioning of the adapter cap. Fundamentally the type of configuration of the abutment means may be freely selected by those skilled in the art; it is only important that the adapter cap is adapted to a shape of the inner surface of the door and/or of the door handle cutout, that the adapter cap may be positioned relative to the inner surface of the door and is automatically positioned in its final position due the adaptation to the shape of the inner surface of the door or the door handle cutout.

An advantageous embodiment of the method provides that when positioning the door handle support on the adapter cap, a surface of the door handle support is abutted against an abutment surface of the adapter cap. Due to the fact that the adapter cap is adapted to the vehicle door and to the door handle support with regard to its dimensions, the application of the door handle support surface of the door handle support on a surface of the adapter cap, provided to this end, the distances between the door handle support and the vehicle door correspond to the required final position of the door handle support.

When disposing the door handle support on the adapter cap, the final positioning of the door handle support is obtained in its projection surface on the door handle cutout, in other words, in a direction which is parallel to a vehicle door surface. This is achieved in that the abutment means of the adapter cap are correspondingly adapted to the vehicle door. Moreover, guiding means of the adapter cap may be adapted to a lateral structure of the door handle support in such a way that the door handle support is positioned in its final position by means of the adapter cap.

When guiding the door handle support in the direction of the door handle cutout, for fastening the door handle support to the fastening adapter, at least a first screw hole and a second screw hole of the adapter cap are provided, through which fastening screws may be guided to the threaded holes of the adapter cap. The first screw hole and the second screw hole, and preferably at least also a third screw hole, are used for passage of a screw to the threaded holes of the adapter cap. A first diameter of the first screw hole and a second diameter of the second screw hole provide a tolerance extent for introducing a screw. The tolerance extent is at least to be conceived in the way that the diameters are larger than the diameters required for the passage of the screws used.

The screw holes are preferably unthreaded.

Due to the fact that the adapter cap is brought into its final position when disposing on the inner surfaces of the doors through the abutment means or the plurality of abutment means, a desired play provided by the screw holes of the adapter cap is provided, in order to compensate for possible position deviations of the fastening adapter. In other words, at least the first and the second screw hole, and preferably also at least a third screw hole, in particular all screw holes of the adapter cap, are provided with an increased diameter, so that when connecting the fastening adapter to the inner surface of the door, a positioning tolerance is ensured. By providing a corresponding tolerance in the connection of the fastening adapter, its connection with the inner surface of the door is obtained with a considerably lower effort and thus last but not least with a high time efficiency. The fact that the positioning of the screw holes on the adapter cap and the positions of the threaded holes of the fastening adapter are adapted to each other is self-explanatory and obvious to those skilled in the art.

It is also preferred that the door handle support has at least a first through hole and a second through hole. The first through hole and the second through hole are positioned on the door handle support and dimensioned in a way that after introducing the door handle positioned on the door handle support in a cutout of the adapter cap, i.e. after positioning the door handle support on the adapter cap, the first through hole position corresponds to the first screw hole and thus also to the first threaded hole and the second through hole position corresponds to the second screw hole and thus also to the second threaded hole. Preferably the positions of all through holes of the door handle support correspond to a respective screw hole and threaded hole of the fastening adapter.

The corresponding positioning of two holes is to be understood in the sense that the holes are positioned one above the other in such a way that, for example, a fastening screw may be guided through both holes.

The through holes are preferably unthreaded.

In particular, according to a development, the first through hole and the second through hole, preferably all through holes have a respective tolerance for the final positioning of the door handle support. In other words, when the position of the adapter cap is defined in its final position and the door handle support is also in its final position, a screw passing through a through hole of the door handle support and through a screw hole of the adapter cap has a specific motion tolerance in a direction parallel to the inner surface of the door. This motion tolerance is preferably at least 0.5 mm, most preferably at least 1 mm for each of the required fastening screws. The tolerance provided by the dimensions of the screw holes and through holes in positioning a screw introduced through a screw hole and through hole means, that already when connecting the adapter cap, a relatively large channel for positioning the fastening adapter is provided, i.e. the precision requirements for the positioning of the fastening adapter may be precisely reduced, which leads to the already mentioned higher time efficiency when fastening the fastening adapter to the inner surface of surface. Due to the fact that differences in the position of the fastening adapter on the inner surface of the door may be compensated within a tolerance by the screw holes of the adapter cap providing a tolerance extent and by the tolerance-providing through holes of the door handle support, a simplification of the mounting operation of the door handle support is ultimately achieved.

The tolerance extents of the screw holes and the tolerances of the through holes are preferably adapted to the positioning precision when connecting the fastening adapter to the inner surface of the door and to a predetermined positioning tolerance for disposing the door handle support relative to the door handle cutout. In other words, the dimensioning and positioning of screw holes and through holes is preferably adapted depending on the tolerances which have to be set in positioning the fastening adapter, when fastening the same.

Another aspect of the invention relates to a door handle fastening set for mounting a door handle support in its final position to a vehicle door. The vehicle door has a door handle cutout. However, the door handle support and vehicle door including the door handle cutout of the vehicle door are not part of the door handle support fastening set. Rather, it is essential that the fastening set comprises a number of components which are adapted to a given vehicle door with an existing door handle cutout and an existing door handle support while vehicle door and door handle support are not customized components, but standard components or, for example, components, which are predetermined by the vehicle manufacturer.

The door handle support fastening set includes a fastening adapter and an adapter cap.

The fastening adapter according to the invention is adapted at least to the vehicle door, in such a way that the fastening adapter may be positioned on an inner surface of the vehicle door, while surrounding, at least partially, the door handle cutout and is connectable to the inner surface of the door. Preferably, the fastening adapter is designed such that it can be connected to the inner surface of the door and after the connection, it runs around the door handle cutout once and thereby comprises a closed line. The fastening adapter includes at least a first threaded hole provided with a screw thread for receiving a first fastening screw and a second threaded hole provided with a screw thread for receiving a second fastening screw. The fastening screws are used for screwing the door handle support to the fastening adapter.

The door handle support fastening set furthermore has an adapter cap which is adapted at least to the vehicle door, preferably also to the door handle support, in that the adapter cap can be arranged above the fastening adapter. The adapter cap is positioned in the final position with respect to the vehicle door by means of one or more abutment means of the adapter cap. This can be done, for example, by introducing the abutment means or the plurality of abutment means in one or more complementary abutment elements of the vehicle door or by applying them into this or these, so that they are supported or guided. In a structurally simple embodiment, the abutment means may be a front edge of the adapter cap, which is adapted to a linear profile on the inner surface of the door, so that the positioning of the adapter cap is brought about by applying the adapter cap to the inner surface of the door.

In one embodiment of the method, preferably the abutment means of the adapter cap is designed as an engagement slot, an engagement spring or an engagement edge. The abutment means is particularly preferably adapted to a complementary receiving structure of the vehicle door in order to bring about the final positioning of the adapter cap by positioning the abutment means onto the adapter cap.

Alternatively or additionally, the abutment means can be a concavity of the adapter cap, which can be brought into abutment with a complementary convexity of the door for final positioning of the abutment means.

According to an advantageous development, the adapter cap has a first screw hole with a first diameter and a second screw hole with a second diameter, wherein positions and diameters of the screw holes are selected such that the first screw hole is positioned corresponding to a first through hole of the door handle support and the second screw hole is positioned corresponding to a second through hole of the door handle support. The screw holes and the through holes are dimensioned and positioned so that a screw passed through a screw hole and a through hole and to be inserted into a threaded hole of the fastening adapter can experience a positioning tolerance in a direction parallel to the inner surface of the door. The fastening screw is thus granted a certain amount of play. In particular, since the adapter cap and door handle support are brought in the final position by corresponding designs and a design with respect to the vehicle door, providing the tolerance results in particular in the fastening adapter, which is not subject to final positioning, being fastened with the tolerance provided.

The final positioning of the door handle support can be accomplished, for example, by a guide element of the door handle support, which cooperates with a complementary guide counter-element of the adapter cap.

The door handle support fastening set provides the advantages explained with respect to the method and its developments in an analogous way. In particular, characteristics of the method may also be combined with characteristics of the door handle support fastening set and characteristics of the door handle support fastening set may be combined with characteristics of the method.

Further details, characteristics and advantages of the subject matter of the invention are obtained from the following description in combination with the drawings, in which an example of the invention is illustrated.

### BRIEF DESCRIPTION OF THE DRAWINGS

It is understood that above said characteristics and the characteristics described in the following may be combined with each other not only in the combinations provided but also in any other combination or in a stand-alone configuration.

In particular:

FIG. 1 shows a door handle support mounted in its final position on the vehicle door with a door handle support fastening set;

FIGS. 2 to 6 show a sequential representation of an exemplary embodiment of the inventive method for mounting a door handle support in a final position on the vehicle door;

FIG. 7 shows a detailed view of the door handle support mounted in its final position on the vehicle door in a posterior view (detail);

FIG. 8 shows a constellation of FIG. 6 in a posterior view;

FIG. 9 shows a door handle support mounted in its final position on the vehicle door with a door handle support fastening set in another perspective view;

FIG. 10 shows a sectional view of the plane shown in FIG. 9.

### DETAILED DESCRIPTION

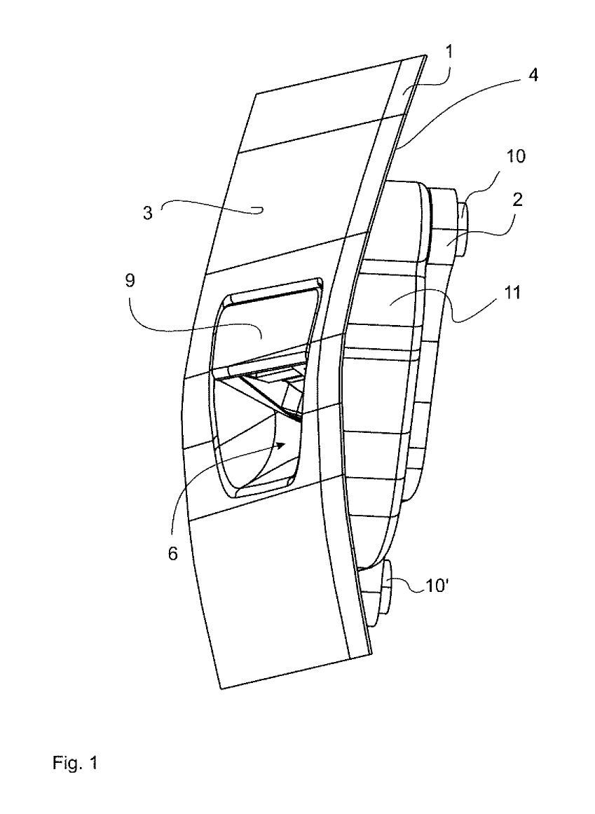

FIG. 1 shows a vehicle door 1 having a door handle support 2 fastened to the vehicle door. It may be seen that between a back side of the vehicle door 1 and the door handle support 2, the adapter cap 11 contributes to the fixing of the distance between the vehicle door 1 and the door handle support 2. The door handle support 2 and the vehicle door 1 are connected to each other by means of three fastening screws, wherein the two fastening screws 10, 10′ are shown in the perspective view. The door handle support 2 provides the outer door handle and its mechanism, such as a push button, a button rotating spring, a Bowden cable lever, an outer door handle rotating spring, etc. The door handle support 2 is arranged such that the outer door handle may be accessed from outside the vehicle through a door handle cutout 6. For esthetical reasons, in the example shown, a paint bezel 9 is attached to the outer door handle, so that the outer door handle is flush with the outer surface of the vehicle door 1.

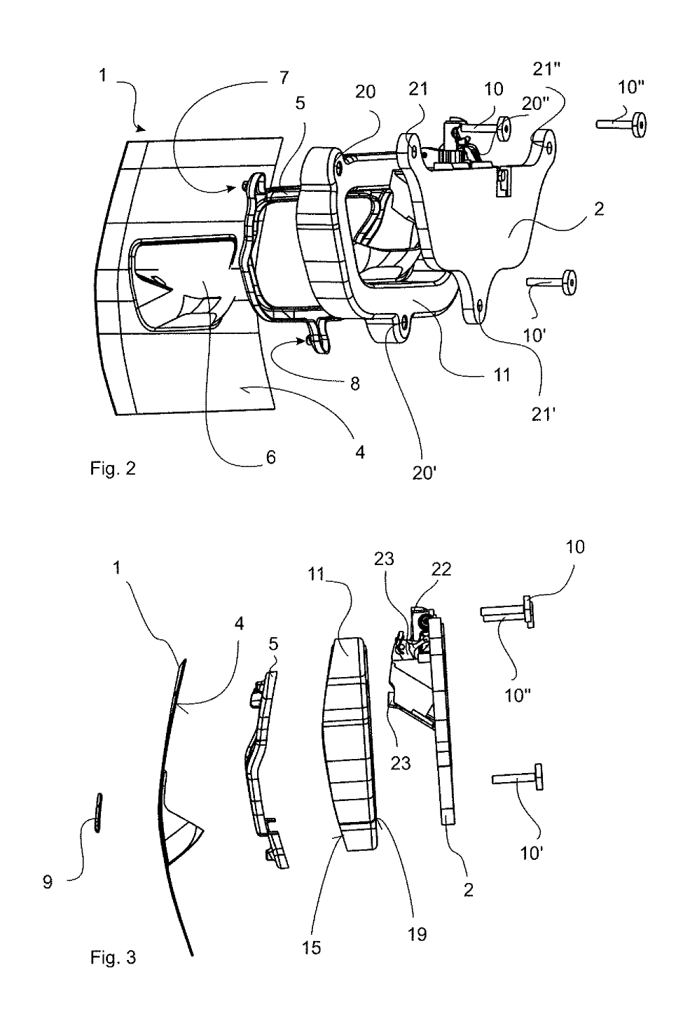

The sequence of the following figures illustrates an example of the inventive method for fastening the door handle support shown in FIG. 1. FIG. 2 shows the initial components, with which the door handle support 2 may be fastened through the inventive method. In the back and oblique view, starting from the vehicle door 1, to the screws 10, 10′, 10″, the components are shown in an exploded view in the order present in the final mounted state. Behind the vehicle door 1, with its door handle cutout 6, a fastening adapter 5 is represented, which in the embodiment shown is provided with three threaded holes. In the perspective selected, from the three present threaded holes a first threaded hole 7 and a second threaded hole 8 may be seen, whereas the third threaded hole is covered by the adapter cap 11. The fastening adapter 5 is in particular used for providing the threaded holes, which are used for receiving the fastening screws 10, 10′, 10″, in order to connect, through the fastening screws 10, 10′, 10″, the door handle support 2, in particular with a force-fit, to the fastening adapter 5 and thus to the vehicle door 1. Behind the fastening adapter 5 an adapter cap 11 is shown, whose lateral side surface is already partially shown in FIG. 1. The adapter cap 11 has three, preferably unthreaded, screw holes for passing the fastening screws. In the perspective shown, two of the three screw holes, i.e. the first screw hole 20 and the second screw hole 20′ are shown. The screw holes are positioned relative to the threaded holes such that a superposition of adapter cap 11 and fastening adapter 5 allows an access to the threaded holes through the screw holes. A door handle support 2 which provides the outer door handle mechanism is positioned behind the adapter cap 11. The door handle support 2 is provided with a mounting device for supporting the outer door handle mechanism, which device is integral with a plate of the door handle support 2. The form of a door handle support 2 and in particular the position of the outer door handle mechanism on the door handle support 2 is known to those skilled in the art. In order to fasten the door handle support 2 to the vehicle door 1, the door handle support is provided with through holes 21, 21′, 21″, which are correspondingly positioned in abutment through the screw holes 20, 20′, 20″ and the threaded holes 7, 8, in order to allow the receiving and passing through of the fastening screws 10, 10″.

FIG. 3 shows the constellation of FIG. 2 in a side view. In addition to the elements already shown in FIG. 2, the paint bezel 9 is shown, which in the example shown is fastened to the outer door handle only after mounting the door handle support in its final position, which occurs by clipping the door handle support to the outer door handle 23 in the example shown. A button 22 is also provided in addition to the outer door handle 23. Moreover a specific form of the edge 15 is shown, which in the example shown is complementary to the shape of the inner surface of the door. Due to the complementary profile of the edge with respect to the inner surface of the door, the edge 15 may be applied onto the inner surface of the door 4 and thus contributes, as an abutment means 15, to the final abutting positioning of the adapter cap 11 onto the inner surface of the door 4.

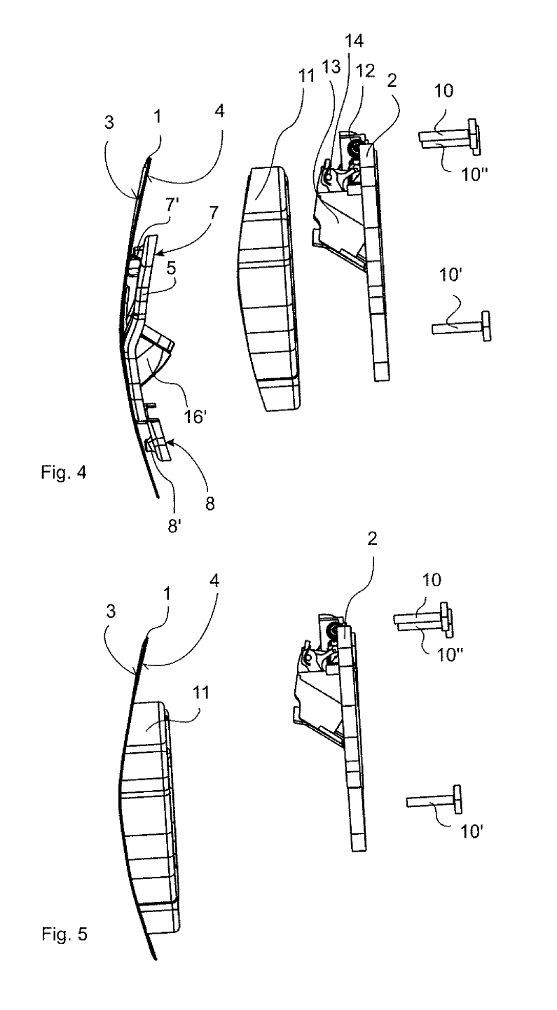

To perform the exemplary embodiment of the inventive method, in a first step the fastening adapter 5, as shown in FIG. 4, is connected to the inner surface of the door 4. In the shown example, the connection occurs by welding. However, also alternative connections may be used, such as gluing or a combination of welding and gluing. As shown in FIG. 4, the fastening adapter 5 completely surrounds the door handle cutout 6, thus forming a closed line, the projection of which on the inner surface of the door completely encircles the door handle cutout 6. This causes that the fastening adapter 5, when viewing vertically on the door handle cutout 6, is invisible to the observer. The fastening adapter 5 is not connected to the inner surface of the door along its entire circumference. Instead, portions of the fastening adapter 5 are present, which are connected to the vehicle door, while other portions of the fastening adapter 5 are separated from the inner surface of the door 4 and are not directly connected to the door. The fastening adapter 5 provides a number of threaded holes, in the example shown the preferred number is three threaded holes, wherein in the perspective shown, the first threaded hole 7 and the second threaded hole 8 are indicated by their respective outer lateral surfaces 7′ and 8′.

As shown in FIG. 5, the adapter cap 11 is positioned over the fastening adapter 5. After the superposition, the adapter cap 11 envelopes the fastening adapter 5 completely, which however is not strictly necessary in all embodiments of the invention. The adapter cap provides an abutment surface 19, which in the embodiment shown is further away from the outer surface of the door 3 than the fastening adapter 5. The convexity 16′ shown in FIG. 4 is included by a complementary concavity 16 of the adapter cap 11; the complementary concavity 16 of the adapter cap in the example shown is thus abutting against the abutting means which is the concavity 16. By the interaction between the abutting means 16 and the convexity 16′, the final positioning of the adapter cap is assisted.

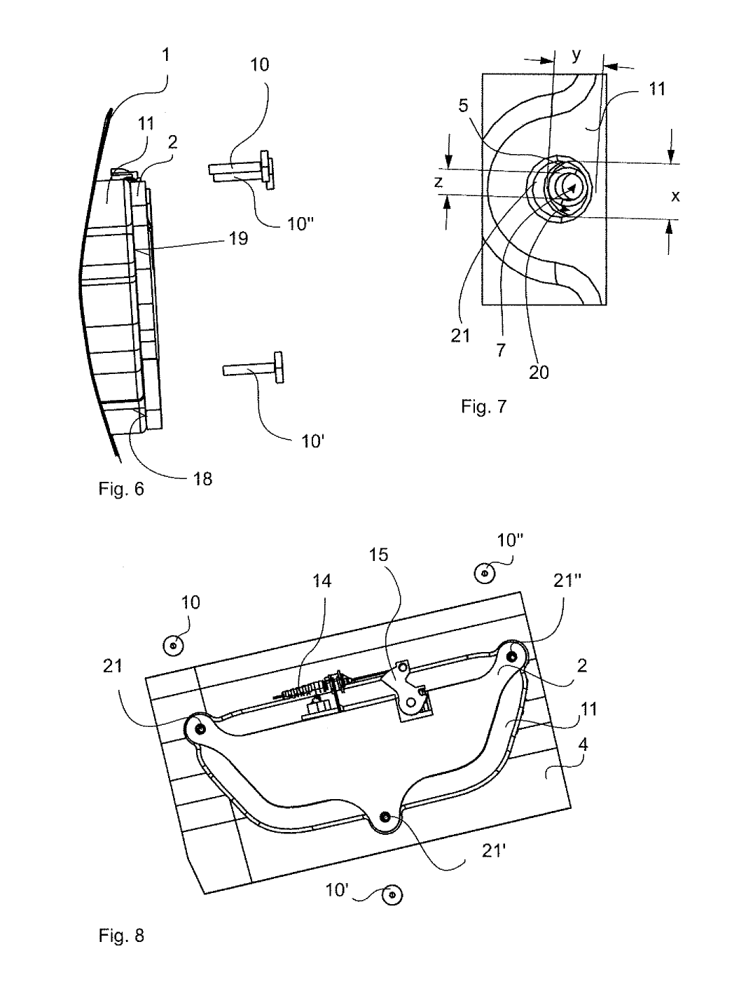

Subsequent to the constellation shown in FIG. 5, as shown in FIG. 6, the door handle support 2 is arranged on the adapter cap 11 by the door handle support surface 18 being positioned abutting on the abutment surface 19 of the adapter cap 11. Preferably, the abutment surface 19, as in the embodiment shown, is formed such that a projection of the abutment surface on the inner surface of the door 4, completely rotates once around the door handle cutout 6, wherein the term abutment surface and the term door handle support surface 18 are to be understood such that the door handle support 18 and abutment surface 19 are formed complementary to each other. The abutment of the door handle support surface 18 on the abutment surface 19 thereby causes at least one depth positioning of the door handle support surface 18. In the simplest case, as well as in the illustrated embodiment, the abutment surface 19 and door handle support surface 18 are each in a plane, so that they have planar components that can be brought into abutment with each other. Because the adapter cap 11 is positioned in its final position, the abutment surface 19 of the door handle support 2 in a direction perpendicular to the door handle support surface 18 causes the positioning of the door handle support 2 in a force-fit engagement of the door handle support 2 in the direction of the inner surface of the door 4.

For the final positioning of the door handle support 2, starting from this constellation, only a fine positioning in the door handle support plane itself is required; the final positioning of the door handle support is preferably carried out by means of corresponding guide elements of the door handle support 2, which cooperate with corresponding guide receiving structures of the adapter cap 11. Also, corresponding guide elements of the adapter cap 11 may be provided, which cooperate with corresponding guide receiving structures of the door handle support 2. The exact procedure for the final positioning of the door handle support itself is not part of the invention, it is essential to provide an adapter cap 11 in a final position and the provision of the fastening adapter 5.

For advantageously carrying out the method according to the invention, the threaded holes and the through holes are provided with the tolerances explained below.

The constellation now present is shown on the basis of the exemplary superposition arrangement of the threaded hole 7, the screw hole 20 and the through hole 21, which can be taken from the sectional view of FIG. 7 in a perspective rear view. In particular, it can be seen that the first diameter y of the first screw hole 20 and the diameter x of the through hole 21 are each larger than the diameter z of the first threaded hole 7. Thus, the first screw hole 20 represents a tolerance extent and the first through hole 21 a tolerance, which together lead to a positioning tolerance of the first threaded hole 7. The sizing of the other screw holes and through holes in relation to the corresponding threaded holes is analogous. The resulting positioning tolerances for the positioning of threaded holes lead to a corresponding positioning tolerance of the fastening adapter 5. The fact that the final position of the adapter cap 11 and the position of the door handle support 2 are defined by the shape of the inner surface of the door, the door and the adapter cap 11 and the door handle support 2 represent a reference, so that the provided positioning tolerance is advantageous for the positioning of the fastening adapter 5. In other words, the fastening adapter 5 can be arranged on the inner surface of the door 4 with an optionally correspondingly wide tolerance when being connected to the inner surface of the door. As a result, a time-efficient and errorless fastening of the fastening adapter 5 is made possible without sacrificing the positioning accuracy of the door handle support 2.

The constellation shown in FIG. 6 is again shown in FIG. 8 in a rear view, the rear view also showing the spring 14 and the Bowden cable lever 15 of the vehicle door mechanism.

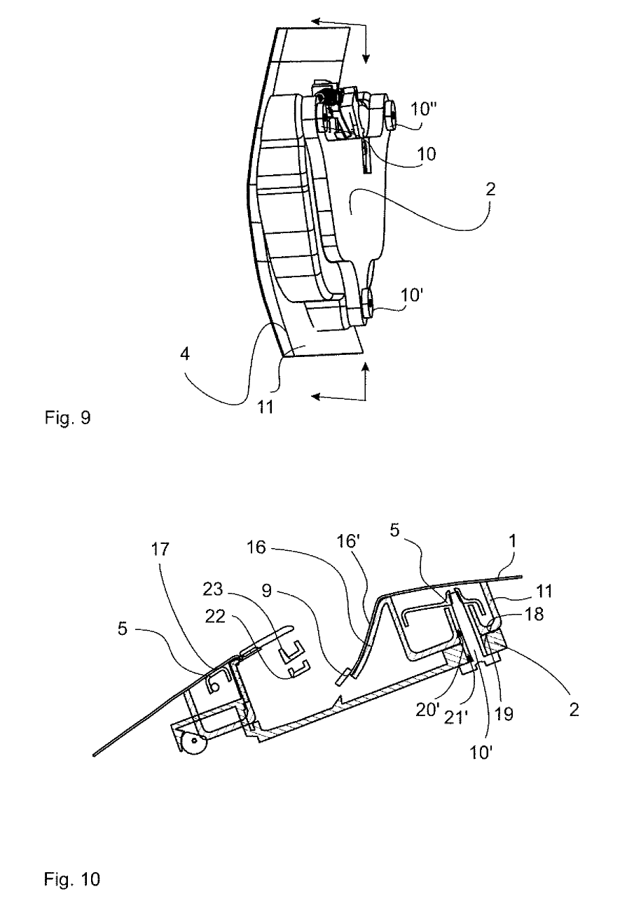

The constellation after force-fitting of the door handle support 2 by means of the screws 10, 10′ and 10″ is shown in FIG. 9 in a rear oblique view. A section in the sectional plane of FIG. 9 is shown in FIG. 10. It can be seen in particular from FIG. 10 that the abutment surface 19 of the adapter cap 11 of the door handle support surface 18 serves as a positioning aid defining the distance of the door handle support 2 from the inner surface of the door 4. Furthermore, FIG. 10 shows how the convexity 16′ of the vehicle door 1 into the vehicle interior serves as an abutment surface with which the concavity 16 is abutted, thereby providing the final positioning of the adapter cap 11. Furthermore, it can be seen how the fastening screw 10′ has a clearance available on both sides of the screw shaft; these are the tolerance extent and tolerance provided on the basis of the dimensioning of the screw hole 20′ and of the through hole 21′, from which a total positioning tolerance of the fastening adapter 5 results, when fastening the fastening adapter to the inner surface of the door.

1. A method for mounting a door handle support in a final position on a vehicle door, wherein the method comprises the following steps:
a) providing a vehicle door having an outer surface and an inner surface,
b) connecting a fastening adapter to the inner surface of the door, wherein the fastening adapter when it is connected to the inner surface of the door surrounds, at least along a portion, a door handle cutout of the vehicle door and wherein the fastening adapter has at least one first threaded hole and a second threaded hole,
c) positioning an adapter cap on the fastening adapter, wherein an abutment means or a plurality of abutment means of the adapter cap are positioned on the inner side in abutment with the vehicle door, for achieving the final positioning of the adapter cap,
d) positioning the door handle support on the adapter cap in an abutting position and fastening the door handle support by means of fastening screws, which are screwed at least into the first threaded hole and into the second threaded hole.

2. The method of claim 1, wherein the fastening adapter is connected to the inner surface of the door by means of gluing and/or welding.

3. The method of claim 1, wherein
the adapter cap has an engagement slot, which engages in an engagement spring of the inner surface of the door, and/or
the adapter cap has an engagement edge, which is positioned in abutment against a boundary edge of the door handle cutout, for final positioning of the adapter cap.

4. The method of claim 1, wherein when positioning the door handle support on the adapter cap, a door handle support surface is positioned in abutment against an abutment surface of the adapter cap, wherein, due to the depth of positioning of the abutment surface being adapted to the vehicle door and the door handle support, the final positioning of the door handle support is achieved in a depth direction.

5. The method of claim 1, wherein when positioning the door handle support on the adapter cap, the final positioning of the door handle support is achieved in its projection surface on the door handle cutout, wherein the adapter cap comprises a first screw hole having a first diameter and a second screw hole having a second diameter, wherein the first diameter and the second diameter respectively provide a tolerance extent for the final positioning of the door handle support with respect to the positions of the threaded holes.

6. The method of claim 5, wherein the door handle support comprises a first through hole in a position corresponding to the first screw hole and a second through hole in a position corresponding to the second screw hole, wherein a first diameter of the first through hole and a second diameter of the second through hole have a respective tolerance for the final positioning of the door handle support with respect to the positions of the threaded holes.

7. A door handle support fastening set for mounting a door handle support in a final position on a vehicle door, which has a door handle cutout, wherein the door handle support fastening set comprises:
a fastening adapter, which is adapted to the vehicle door at least in a way that the fastening adapter may be positioned on an inner surface of the door, such that it at least partially surrounds the door handle cutout and may be connected to the inner surface of the door, wherein the fastening adapter has at least a first threaded hole for receiving a first fastening screw and a second threaded hole for receiving a second fastening screw, for adapting the same for fastening the door handle support by means of the first fastening screw and the second fastening screw on the fastening adapter,
an adapter cap, which is adapted to the vehicle door at least in a way that the adapter cap may be positioned over the fastening adapter, wherein an abutment means or a plurality of abutment means of the adapter cap may be positioned in abutment against the vehicle door, in order to achieve the final positioning of the adapter cap.

8. The door handle support fastening set of claim 7, wherein the abutment means of the adapter cap is an engagement slot, an engagement spring or an engagement edge, wherein the abutment means is adapted to a complementary receiving structure of the vehicle door, for the final positioning of the adapter cap by applying the abutment means on the receiving structure and/or
that the abutment means of the adapter cap is formed by a concavity, wherein the abutment means is adapted to a complementary convexity of the vehicle door, for the final positioning of the adapter cap by applying the abutment means on the receiving structure.

9. The door handle support fastening set of claim 7, wherein the adapter cap has a first screw hole having a first diameter and second screw hole having a second diameter, wherein the positions and the diameters of the screw holes are selected in a way that the first screw hole is in a position corresponding to a first through hole of the door handle support and the second screw hole is in a position corresponding to a second through hole of the door handle support and the screw holes respectively have a tolerance extent for providing a position tolerance in a plane which is parallel to a door plane, for the final positioning of the door handle support.
